(19) United States
(12) Patent Application Publication
(10) Pub. No.: US 2025/0052563 A1
(43) Pub. Date: Feb. 13, 2025

(54) TOOL LIFE PREDICTION METHOD

(71) Applicant: DAEGU MECHATRONICS & MATERIALS INSTITUTE, Daegu (KR)

(72) Inventors: Ik-Soo KANG, Daegu (KR); Yun-Chul JUNG, Gyeongsangnam-do (KR); Il-Chae YOON, Daegu (KR); Jae-Young HEO, Daegu (KR); Jae-Ryung LEE, Daejeon (KR)

(73) Assignee: DAEGU MECHATRONICS & MATERIALS INSTITUTE, Daegu (KR)

(21) Appl. No.: 18/724,829

(22) PCT Filed: Dec. 26, 2022
(86) PCT No.: PCT/KR2022/021318

§ 371 Date: Jun. 27, 2024

(30) Foreign Application Priority Data
Dec. 27, 2021 (KR) 10-2021-0188336

(51) Int. Cl. G01B 11/24; B23B 25/06

(52) U.S. Cl. CPC G01B 11/24; B23B 25/06

(57) ABSTRACT

A tool life prediction method according to the present disclosure comprises: allowing a target tool having a rake surface and a clearance surface to perform cutting under specific test conditions; obtaining three-dimensional shape data including the rake surface and the clearance surface of the target tool performing the cutting; calculating the wear volume from a difference between a first cross-sectional profile corresponding to the three-dimensional shape data and a second cross-sectional profile corresponding to shape data before processing; obtaining an immeasurable value in a tool wear volume calculation formula through simulation; deriving a plurality of constant values included in the tool wear volume calculation formula, based on the wear volume and the value obtained through the simulation; and predicting the wear volume of the tool by using the derived constant values.

### TECHNICAL FIELD

The present disclosure relates to a method of predicting the life of a cutting tool.

### BACKGROUND ART

A tool cuts workpiece, but wears itself out over time, reducing cutting power and deteriorating machining quality. The tool wear varies in type, and occurs through complex mechanisms such as plastic deformation, abrasion, adhesion, diffusion, oxidation, and chipping.

As the tool wear progresses, the time it takes for the tool to reach a state where the tool is no longer suitable for cutting may be considered the life of the tool. Whether the tool has reached its life may be determined from the occurrence of gloss on a polishing surface, a wear volume of a cutting edge, a change in polishing dimensions, a sharp increase in cutting resistance, etc. However, these causes are ex post facto, and it is necessary to predict the wear volume before the tool reaches its life so that the optimal replacement time may be estimated in advance.

High cutting temperature, work hardening, chemical reaction between a tool and workpiece, and plastic deformation that may occur locally during cutting difficult-to-cut materials such as heat-resistant alloy (e.g., Inconel718) cause aggravated the tool wear. As a result, the life of tools for cutting the difficult-to-cut materials is much shorter than that of regular tools, and the tools are often more expensive. Therefore, it is important to select conditions that can improve life and predict the tool replacement time by accurately predicting the tool wear.

To predict the tool wear, it is necessary to select a model and derive model constants. Most of the existing researches or technologies were to measure or theoretically calculate a length (VB, mm) of a clearance surface to derive tool model constants and predict clearance surface wear using a model formula. These methods do not accurately measure the shape of the worn tool and are not the derivation process accordingly, and therefore, inevitably have limitations in the reliability of predicted values.

### RELATED ART

Korean Patent No. 10-1662820 (Registered on Sep. 28, 2016)
Korean Patent Laid-Open Publication No. 10-2012-0064888 (Published on Jun. 20, 2012)
Korean Patent Laid-Open Publication No. 10-2017-0031906 (Published on Mar. 22, 2017)
Japanese Patent Laid-Open Publication No. 2021-130159 (Published on Sep. 9, 2021)

### DISCLOSURE

### Technical Problem

The present disclosure provides a method capable of reliably predicting tool wear by calculating an accurate wear rate based on tool wear shape measurement.

### Technical Solution

In one general aspect, a tool life prediction method includes: allowing a target tool having a rake surface and a clearance surface to perform cutting under specific test conditions; obtaining three-dimensional shape data including the rake surface and the clearance surface of the target tool that has performed the cutting; calculating a wear volume from a difference between a first cross-sectional profile corresponding to the three-dimensional shape data and a second cross-sectional profile corresponding to a shape data before processing; obtaining an immeasurable value in a tool wear volume calculation formula through simulation; deriving a plurality of constant values included in the tool wear volume calculation formula based on the wear volume and the values obtained through the simulation; and predicting the wear volume of the tool using the derived constant values.

The acquiring of the three-dimensional shape data including the rake surface and the clearance surface of the target tool performing the cutting may include optically capturing the target tool while tilted at 45° so that the rake surface and the clearance surface may be measured simultaneously.

The obtaining of the three-dimensional shape data including the rake surface and the clearance surface of the target tool performing the cutting may include determining the first cross-sectional profile by calculating an average value from the cross-sectional profiles obtained for each of a plurality of measurement lines at equal intervals perpendicular to an edge line where the rake surface and the clearance surface are in contact.

The allowing of the target tool having the rake surface and the clearance surface to perform the cutting under the specific test conditions may include taking the plurality of target tools and allowing each of the plurality of taken target tools to perform the cutting so that the specific test conditions are applied differently.

In the allowing of the target tool having the rake surface and the clearance surface to perform the cutting under the specific test conditions, the cutting may be performed by setting at least one of a cutting speed (VC), a feed (FN), and a cutting depth (AP) of the specific test conditions differently for the plurality of target tools.

The deriving of the plurality of constant values included in the tool wear volume calculation formula may include calculating the plurality of target tools performing the cutting for each of the specific test conditions by dividing the plurality of target tools into a first case group larger than the standard tool wear rate and a second case group smaller than the standard tool wear rate.

The deriving of the plurality of constant values included in the tool wear volume calculation formula may include applying different tool wear volume calculation formulas to a case belonging to the first case group and a case belonging to the second case group.

Under the conditions of the cutting speed (VC) of 50 to 90 m/min, the feed (FN) of 0.15 to 0.25 mm/rev, and the cutting depth (AP) of 1.0 mm, the standard tool wear rate may be set to 0.0015 to 0.0025 mm³/min.

The tool wear volume calculation formula may be at least one of the following (1) or (2).

$$dw / dt = {C}_{1} \cdot exp ( - {C}_{2} / {T}_{K} ) \cdot {V}_{s} \qquad ( 1 )$$

$$dw / dt = {C}_{1} \cdot exp ( - {C}_{2} / {T}_{K} ) \cdot {σ}_{N} \cdot {V}_{s} \qquad ( 2 )$$

Here, dw/dt may denote the wear rate, C₁ and C₂ may denote model constant values, σ_{N} may denote a normal stress of the clearance surface, and Vs may denote the cutting speed.

The target tool may include cemented carbide, and the workpiece cut with the target tool may include a heat-resistant alloy containing nickel (Ni).

The predicting of the wear volume of the tool using the derived constant values may include calculating the wear volume of the tool through the temperature and cutting speed derived from the simulation.

The allowing of the target tool having the rake surface and the clearance surface to perform the cutting under the specific test conditions may include forming the workpiece to be cut by the target tool so that a cutting area has a cylindrical shape with a certain thickness and performing two-dimensional cutting using the workpiece.

### Advantageous Effects

According to a tool life prediction method according to the present disclosure, by calculating a wear volume based on three-dimensional shape data including a rake surface and a clearance surface of the tool where wear occurs to calculate a wear rate and then determining constant values of the tool wear volume calculation formula based on a normal stress and cutting temperature obtained through simulation, it is possible to approximate the actual appearance of the wear and significantly improve the reliability of prediction results compared to the conventional method of simply measuring and predicting a wear length. This method can provide very useful results in predicting the wear of the tool that process high heat-resistant alloys such as Inconel as workpiece, and can improve the cost efficiency of the tool required and the cutting quality of the product.

According to an example according to the present disclosure, in the step of deriving the constant values, by calculating a tool separately into a first case group and a second case group that are larger than a standard tool wear rate, it is possible to reduce the error in the predicted value according to a feed amount and increase the reliability.

### BRIEF DESCRIPTION OF THE DRAWINGS

FIG. 1 is a flowchart for exemplarily describing a tool life prediction method according to the present disclosure.

FIG. 2 is a photograph illustrating an experiment in which a workpiece is cut using a target tool to predict the life of the tool.

FIG. 3 is a diagram visually illustrating three-dimensional measurement results for the target tool that performs cutting for a specific time.

FIG. 4 is an image conceptually illustrating an acquisition of a cross-sectional profile along a plurality of measurement lines perpendicular to an edge line where a rake surface and a clearance surface are in contact.

FIG. 5 is a diagram conceptually illustrating calculating a wear volume and wear rate of the tool based on a change in cross-sectional profile as the cutting progresses.

FIG. 6 is a table illustrating an embodiment according to the present disclosure, in which test conditions are set differently for each target tool.

FIG. 7 is diagrams illustrating a graphical representation of three-dimensional measurement data of each target tool according to the test conditions in FIG. 6.

FIG. 8 is images illustrating the concept of obtaining immeasurable values through simulation according to the present disclosure.

FIG. 9 is diagrams illustrating the acquired temperature and normal stress for each target tool in relation to FIG. 8.

FIG. 10 is comparison diagrams of the results of deriving various wear rates for each target tool with different test conditions.

FIG. 11 is a diagram conceptually illustrating case groups divided according to the wear rate in relation to FIG. 10.

FIG. 12 is diagrams illustrating the results of regression analysis for each case group using a first tool wear volume calculation formula to determine constant values in relation to the present disclosure.

FIG. 13 is diagrams illustrating the results of regression analysis for each case group using a second tool wear volume calculation formula to determine the constant values in relation to the present disclosure.

FIG. 14 is a diagram illustrating the wear volume over time by comparing actual measurement results and wear volume calculation formula models for each tool.

FIG. 15 is comparison diagrams of tool wear predicted based on a first tool wear volume calculation formula model and the actual measurement results.

FIG. 16 is comparison diagrams of tool wear predicted based on a second tool wear volume calculation formula model and the actual measurement results.

### BEST MODE

Hereinafter, a tool life prediction method according to the present disclosure will be described in detail with reference to the attached drawings.

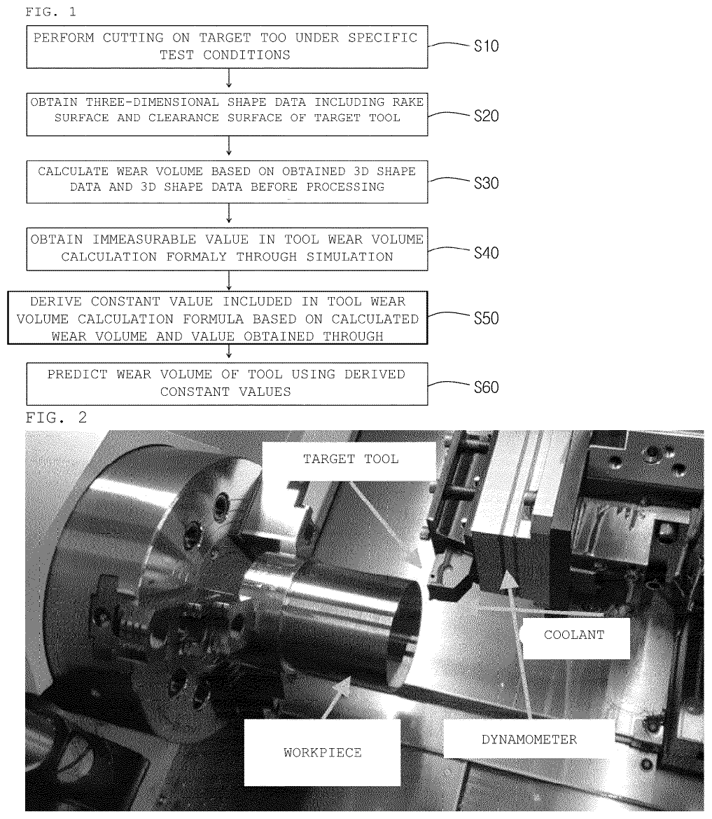

FIG. 1 illustrates each step of the tool life prediction method according to the present disclosure in the form of a flowchart. The tool life prediction method includes allowing a target tool to perform cutting through experiments (S10), obtaining 3D shape data for the worn target tool (S20), calculating a wear volume based on the obtained 3D shape data (S30), obtaining values that are difficult to know through the experiment in the tool wear volume calculation formula through simulation (S40), deriving a constant value based on the value obtained through 3D measurement results and the value found through the simulation (S50), and ultimately, predicting the wear volume of the tool (S60). Each step will be described in detail with reference to the drawings in FIG. 2 and below.

An embodiment of the present disclosure may be an effective solution to more accurately predict a wear volume and life of a target tool containing cemented carbide when a workpiece is a workpiece containing heat-resistant alloy containing nickel (Ni), such as Inconel718, known as a representative difficult-to-cut material.

First, in the step (S10) of allowing the target tool to perform the cutting under specific test conditions, as illustrated in FIG. 2, the workpiece is cut using the target tool (illustrating the form that an insert is inserted into a holder). A dynamometer may be installed on the target tool to measure a force applied to the tool. As an exemplary shape of the workpiece, the cutting area may be in the form of a cylinder with a certain thickness. Accordingly, the thickness of the workpiece naturally becomes a cutting depth AP. Depending on the test conditions, the thickness of the workpiece, that is, the cutting depth, may be determined in various ways.

The target tool may use a plurality of samples. In this case, the specific test conditions may be applied differently for each target tool. As illustrated in FIG. 6, the test conditions may produce various test results by setting at least one of a cutting speed (VC), a feed (FN), and the cutting depth (AP) differently. These test conditions are also an effective cutting condition range for heat-resistant alloys.

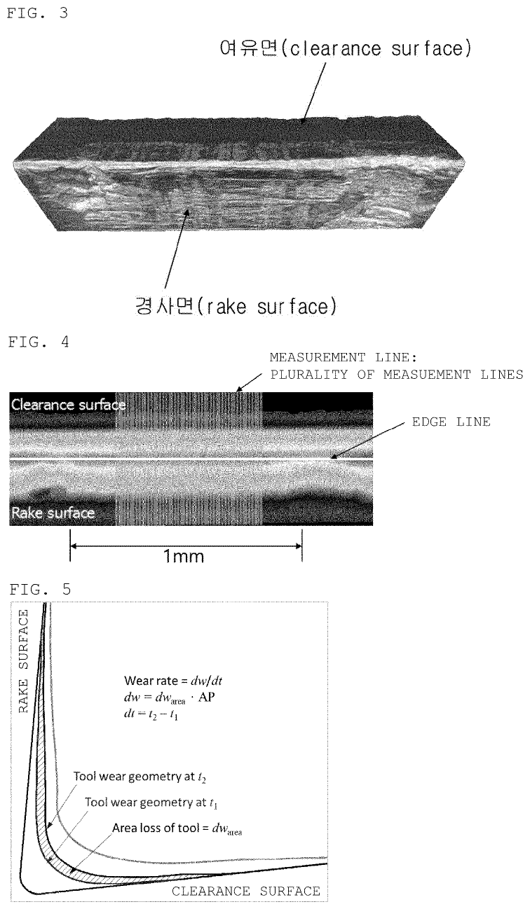

In the step (S20) of obtaining the 3D shape data for the target tool that has performed the cutting, as illustrated in FIG. 3, all wear occurring on a rake surface and a clearance surface of the target tool is reflected in the measurement. In other words, since the wear generated during processing is measured for both the rake surface and the clearance surface, the existing method of predicting only the clearance surface wear by simply measuring or calculating the length of the clearance surface is fundamentally improved. For this purpose, to measure the rake surface and the clearance surface simultaneously, the target tool may be optically captured using a high magnification (e.g., 10×) lens in a vertical direction while tilted at 45°. FIGS. 3 and 4 illustrate the three-dimensional measurement of the target tool that has performed the cutting for a certain period of time. FIG. 4 illustrates a plurality of measurement lines at equal intervals perpendicular to an edge line where the rake surface and the clearance surface are in contact. This is used to calculate an average value from a set of cross-sectional profiles obtained for each measurement line in order to calculate the wear volume described later.

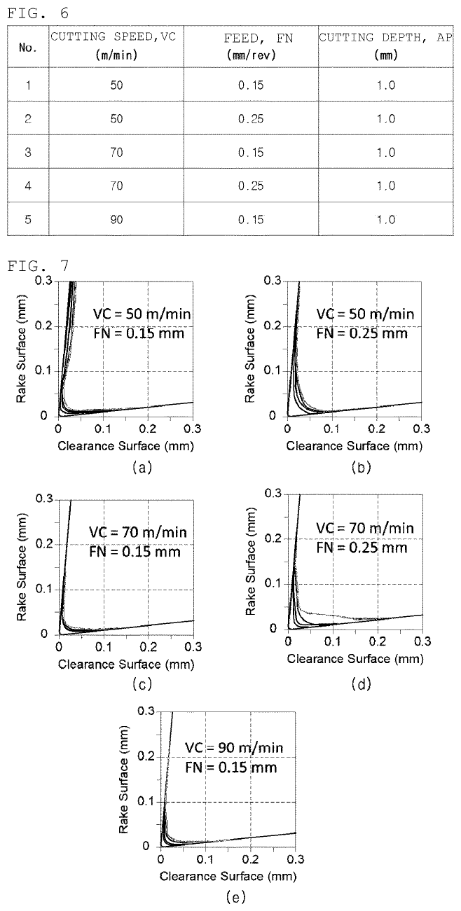

In the step (S30) of calculating the wear volume, the wear volume is calculated from a difference between a first cross-sectional profile corresponding to the three-dimensional shape data and a second cross-sectional profile corresponding to a shape data before processing. FIG. 5 is a diagram conceptually illustrating calculating a wear volume and wear rate of the tool based on a change in cross-sectional profile as the cutting progresses. In the step of calculating the wear volume, the wear volume is an area (shaded area; area loss of tool=dwₐᵣₑₐ) resulting from a difference between a cross-sectional profile before processing (tool wear geometry at t₁) and a cross-sectional profile after processing (tool wear geometry at t₂), and dw is derived by multiplying the area by the cutting depth. The wear rate is obtained by dividing the obtained dw by the elapsed time (t₂−t₁). In this case, as described above, a plurality of cross-sectional profiles (50 in this example) were obtained along the measurement line, and the average value of these was obtained to obtain the final wear shape. When the 3D wear data obtained in this way is stored as a CAD file (dxf), the stored file is loaded to draw a new tool shape, a volume loss may be calculated through the difference between two tool shapes.

FIG. 7 illustrates a graphical representation of the 3D measurement data of each target tool according to the test conditions in FIG. 6, and the profiles are displayed by color classification according to the passage of cutting time. All of these are not simply the wear length of the clearance surface as described above, but are three-dimensional shapes by the combination of the clearance surface and the rake surface.

Through the 3D shape data, the wear volume of the worn target tool may be accurately calculated at any point in time.

The present disclosure proposes a method of obtaining values that are difficult to measure through simulation together with actual measurement values and combining these values.

A tool wear model is used to predict wear. The prediction method of the present disclosure may use the known tool wear model. (1) below is a temperature dependent model, and (2) below is a Usui model. In some cases, one of these models shows better results than the other through the comparison of the predicted tool wear volume and experimental values.

$$dw / dt = {C}_{1} \cdot exp ( - {C}_{2} / {T}_{K} ) \cdot {V}_{s} \qquad ( 1 )$$

$$dw / dt = {C}_{1} \cdot exp ( - {C}_{2} / {T}_{K} ) \cdot {σ}_{N} \cdot {V}_{s} \qquad ( 2 )$$

Here, dw/dt may denote the wear rate, C₁ and C₂ may denote model constant values, σ_{N} may denote a normal stress of the clearance surface, and Vs may denote the cutting speed.

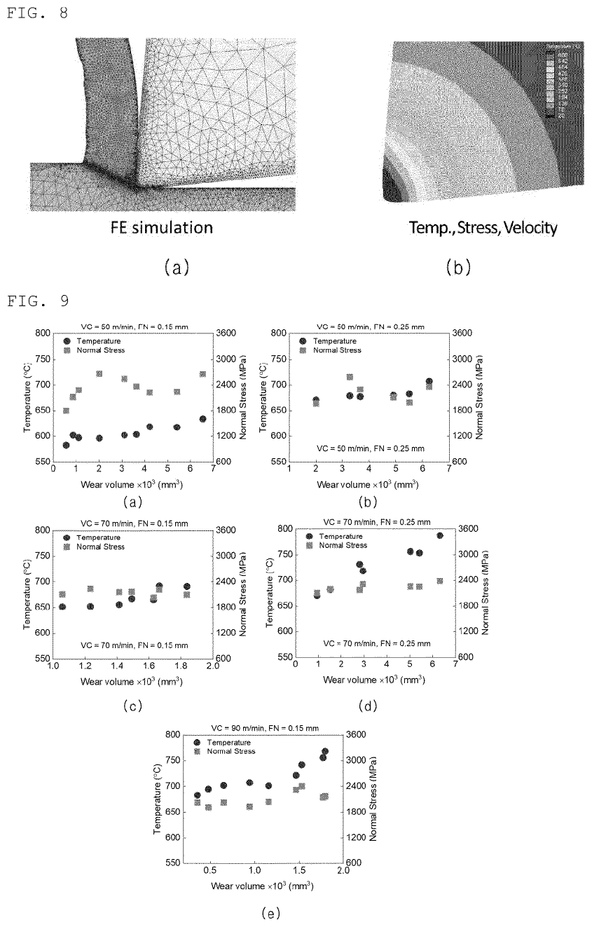

In the above two tool wear models, dw/dt may be obtained by acquiring the 3D shape data and calculating the wear volume, but the temperature or normal stress are difficult to measure, so they may be obtained through the simulation. For this purpose, the normal stress, the cutting speed and the cutting temperature may be obtained using FE simulation, as illustrated in FIG. 8(a) or 8(b). FIG. 9 is diagrams illustrating the acquired temperature and normal stress for each target tool in relation to FIG. 8.

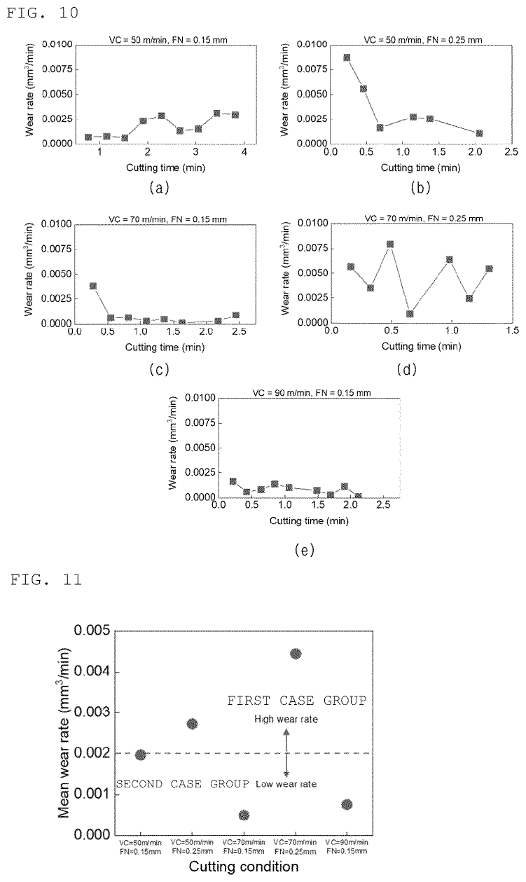

FIG. 10 is comparison diagrams of the results of deriving various wear rates for each target tool with different test conditions. In other words, the wear rate for each target tool may change over time, but generally, it can be seen that the difference is greater depending on the test conditions of each target tool. When each target tool and the average wear volume are displayed on one graph, it is derived as illustrated in FIG. 11, which makes it possible to divide case groups based on the standard tool wear rate of about 0.002 mm³/min. Specifically, a first case group may be a first target tool (VC=50 m/min, FN=0.15 mm), a second target tool (VC=50 m/min, FN=0.25 mm), and a fourth target tool (VC)=70 m/min, FN=0.25 mm), and a second case group may be a third target tool (VC=70 m/min, FN=0.15 mm) and a fifth target tool (VC=90 m/min, FN=0.15 mm). Accordingly, the first case group is higher than the standard tool wear rate, and the second case group is lower than the standard tool wear rate.

In the step (S50) of deriving the plurality of constant values included in the tool wear volume calculation formula, it may be confirmed that calculating the plurality of target tools by dividing them performing for each specific test condition into the first case group larger than the standard tool wear rate and the second case group smaller than the standard tool wear rate may produce better results in comparison with the actual measurement value. Specifically, when belonging to the first case group and when belonging to the second case group, different tool wear volume calculation formulas may be applied.

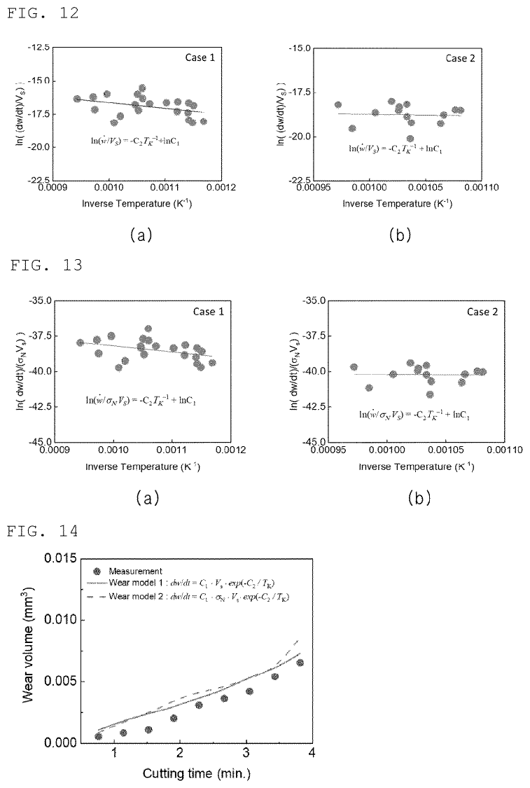

FIG. 12 is diagrams illustrating the results of regression analysis for each case group using a first tool wear volume calculation formula to determine constant values in relation to the present disclosure, and FIG. 13 is diagrams illustrating the results of regression analysis for each case group using a second tool wear volume calculation formula to determine the constant values in relation to the present disclosure. From these, it can be seen that the correlation between the results is higher when the first case group (Case 1) and the second case group (Case 2) are separately displayed.

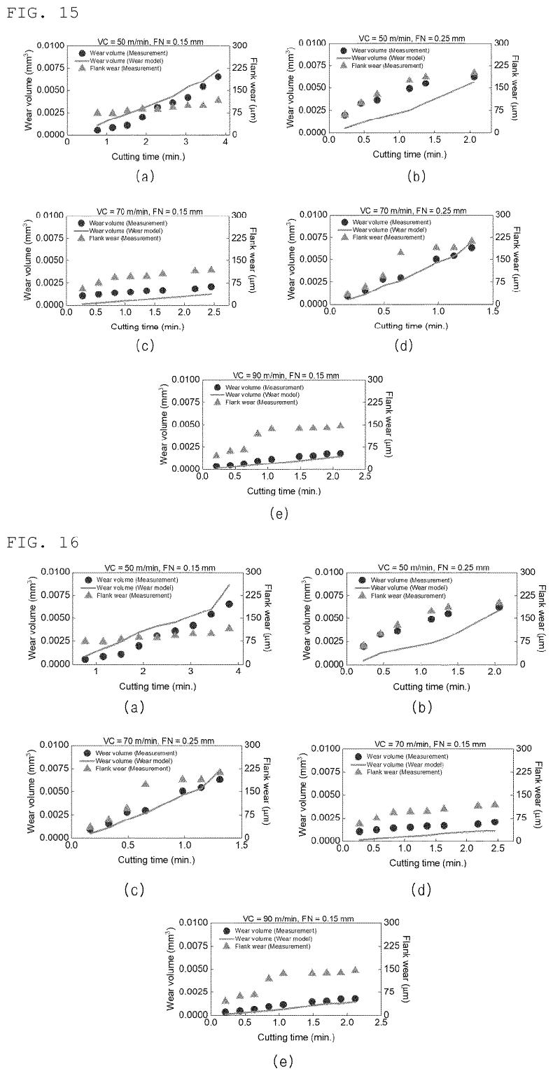

FIG. 14 is a diagram illustrating the wear volume over time by comparing actual measurement results and wear volume calculation formula models for each tool, FIG. 15 is comparison diagrams of tool wear predicted based on a first tool wear volume calculation formula model and the actual measurement results, and FIG. 16 is comparison diagrams of tool wear predicted based on a second tool wear volume calculation formula model and the actual measurement results.

It is ideal to determine one model constant value that satisfies all test conditions, but the difference in tool wear rates may occur depending on the test conditions, and when only one model equation is used, the error in the predicted value will increase depending on the feed amount, so, to take these differences into account, the constant value of the tool wear model formula was determined by dividing into the high and low tool wear rate conditions.

When predicting the tool wear volume through this method, the error from the experimental result at the cutting end time for the first case group was about 10%, and the test conditions for the third target tool of the first case group showed that the error increases relatively further. In other words, although it has partially low prediction accuracy under one specific condition (cutting speed 70, feed amount 0.15), since it is possible to predict less than 20% in the remaining conditions, it can be used as a highly reliable wear prediction method in the corresponding condition range.

The tool life prediction method described above is not limited to the configuration and method of the described embodiments. All or some of the respective exemplary embodiments may be selectively combined with each other so that the exemplary embodiments described above may be variously modified.

1. A tool life prediction method, comprising:
allowing a target tool having a rake surface and a clearance surface to perform cutting under specific test conditions;
obtaining three-dimensional shape data including the rake surface and the clearance surface of the target tool performing the cutting;
calculating a wear volume from a difference between a first cross-sectional profile corresponding to the three-dimensional shape data and a second cross-sectional profile corresponding to a shape data before processing;
obtaining an immeasurable value in a tool wear volume calculation formula through simulation;
deriving a plurality of constant values included in the tool wear volume calculation formula based on the wear volume and the values obtained through the simulation; and
predicting the wear volume of the tool using the derived constant values.

2. The tool life prediction method of claim 1, wherein the acquiring of the three-dimensional shape data including the rake surface and the clearance surface of the target tool performing the cutting includes optically capturing the target tool while tilted at 45° so that the rake surface and the clearance surface may be measured simultaneously.

3. The tool life prediction method of claim 1, wherein the obtaining of the three-dimensional shape data including the rake surface and the clearance surface of the target tool performing the cutting includes determining the first cross-sectional profile by calculating an average value from the cross-sectional profiles obtained for each of a plurality of measurement lines at equal intervals perpendicular to an edge line where the rake surface and the clearance surface are in contact.

4. The tool life prediction method of claim 1, wherein in the allowing of the target tool having the rake surface and clearance surface to perform the cutting under the specific test conditions, the target tool includes a process of taking target tools in plurality and allowing each of the plurality of taken target tools to perform the cutting so that the specific test conditions are applied differently.

5. The tool life prediction method of claim 4, wherein in the allowing of the target tool having the rake surface and clearance surface to perform the cutting under the specific test conditions, the cutting is performed by setting at least one of a cutting speed (VC), a feed (FN), and a cutting depth (AP) of the specific test conditions differently for the plurality of target tools.

6. The tool life prediction method of claim 5, wherein the deriving of the plurality of constant values included in the tool wear volume calculation formula includes calculating the plurality of target tools performing the cutting for each of the specific test conditions by dividing the plurality of target tools into a first case group larger than the standard tool wear rate and a second case group smaller than the standard tool wear rate.

7. The tool life prediction method of claim 6, wherein the deriving of the plurality of constant values included in the tool wear volume calculation formula includes applying different tool wear volume calculation formulas to a case belonging to the first case group and a case belonging to the second case group.

8. The tool life prediction method of claim 6, wherein under the conditions of the cutting speed (VC) of 50 to 90 m/min, the feed (FN) of 0.15 to 0.25 mm/rev, and the cutting depth (AP) of 1.0 mm, the standard tool wear rate is set to 0.0015 to 0.0025 mm³/min.

9. The tool life prediction method of claim 1, wherein the tool wear volume calculation formula is at least one of the following (1) or (2).
$$dw / dt = {C}_{1} \cdot exp ( - {C}_{2} / {T}_{K} ) \cdot {V}_{s} \qquad ( 1 )$$
$$dw / dt = {C}_{1} \cdot exp ( - {C}_{2} / {T}_{K} ) \cdot {σ}_{N} \cdot {V}_{s} \qquad ( 2 )$$
Here, dw/dt denotes the wear rate, C₁ and C₂ denote model constant values, σ_{N} denotes a normal stress of the clearance surface, and Vₛ denotes the cutting speed.

10. The tool life prediction method of claim 1, wherein the target tool includes cemented carbide, and
the workpiece cut with the target tool includes a heat-resistant alloy containing nickel (Ni).

11. The tool life prediction method of claim 1, wherein the predicting of the wear volume of the tool using the derived constant values includes calculating the wear volume of the tool through the temperature and cutting speed derived from the simulation.

12. The tool life prediction method of claim 1, wherein the allowing of the target tool having the rake surface and the clearance surface to perform the cutting under the specific test conditions includes forming the workpiece to be cut by the target tool so that a cutting area has a cylindrical shape with a certain thickness and performing two-dimensional cutting using the workpiece.
